(19) United States
(12) Patent Application Publication
(10) Pub. No.: US 2024/0280950 A1
(43) Pub. Date: Aug. 22, 2024

(54) Smart environment control device using prioritized thermal sensing to trigger personalized functions

(71) Applicants: Sudhakar Ravuri, Fremont, CA (US); Ye Xiong, Elk Grove, CA (US)

(72) Inventors: Sudhakar Ravuri, Fremont, CA (US); Ye Xiong, Elk Grove, CA (US)

(21) Appl. No.: 18/110,554

(22) Filed: Feb. 16, 2023

(51) Int. Cl. G05B 15/02; H04L 9/40; H04N 7/18; H04N 23/23; H04N 23/90

(52) U.S. Cl. CPC G05B 15/02; H04L 63/0861; H04L 63/102; H04N 7/181; H04N 23/23; H04N 23/90; H04L 67/12

(57) ABSTRACT

An environment control network and method for controlling a supervised environment deploying one or more environment control devices equipped with at least one thermal viewer with a thermal field of view on a user interaction area and also at least one optical viewer with a visual field of view on the user interaction area. The control device also has at least one proximity sensor, at least one audio sensor and a microcontroller. The network includes smart devices in communication with the environment control device. Authorized user presence is established by verification of authorized user credentials and further based on user detection through thermal imaging and at least one other detection method. Continued user presence in the user interaction area is monitored with precedence given to thermal imaging upon at first establishing authorized user presence in the user interaction area.

### FIELD OF THE INVENTION

This invention relates generally to an environment control network that deploys at least one smart environment control device that gives precedence to thermal sensing over other sensing modalities to trigger personalized functions for a user of the network while the user is located in a user interaction area.

### BACKGROUND

Many low-cost sensing technologies exist for monitoring locations that include indoor and outdoor spaces. The most widely used technologies in these contexts are thermal imaging, optical imaging, proximity sensing, motion detection as well as acoustic sensing. Combinations of these technologies and the associated sensors have enabled various systems for monitoring and controlling such monitored locations. These types of monitoring systems focus primarily on providing functions that include surveillance, protection, security, recording, capture, generation of alerts, user comfort/luxury and still other functions.

Some monitoring systems use optical and thermal imagers in conjunction with still other sensors. While the visual and infrared sensing are complementary in many ways, their application in monitoring systems has not leveraged their advantages. In fact, there are a number of shortcomings in present multi-sensor monitoring systems that use thermal imaging.

### OBJECTS OF THE INVENTION

In view of the shortcomings of the prior art, it is an object of the invention to provide a smart environment network that uses a smart environment control device that more efficiently manages the sensing resources. In particular, it is an object of the invention to provide for a smart environment device that leverages thermal imaging in performing its functions.

These and other objects and advantages of the present invention will become apparent upon review of the detailed description and the appended drawing figures.

### SUMMARY

The benefits of the present invention are secured by an environment control network for controlling a supervised environment that can be established in many different locations and settings. For example, the supervised environment can be, among other, a home environment, an office environment, an industrial environment, an outdoor environment, an indoor environment. The environment control network for controlling such supervised environment has an environment control device equipped with a number of parts or elements. In particular, the environment control device has at least one thermal viewer whose thermal field of view is trained on a certain part of the supervised environment where the user is expected to be present. This certain part of the supervised environment is herein called a user interaction area.

The environment control device, also referred to as a node when multiple such devices are present in the network, also has at least one optical viewer whose visual field of view is set to perform optical imaging of the user interaction area. Note that the thermal field of view of the thermal viewer and the visual field of view of the optical viewer are both trained on the user interaction area. However, this does not mean that the thermal field of view and the visual field of view need to completely overlap. In fact, a partial overlap can be sufficient in many embodiments of the invention.

The environment control device is also equipped with at least one proximity sensor for proximity sensing within the user interaction area. Specifically, the proximity sensor can sense an object associated with the user or the user. Sensing the user includes sensing or detecting hand or body gestures. Further, environment control device has at least one audio sensor for picking up sounds or audio sensing within the user interaction area.

Still further, environment control device has a microcontroller. The microcontroller is connected to the at least one thermal viewer for obtaining a thermal image, and it is connected to the at least one optical viewer for obtaining an optical image, and it is also connected to the at least one proximity sensor for obtaining a proximity read, and it is further also connected to said at least one audio sensor for obtaining an audio signal.

The environment control network has at least one smart device in communication with the environment control device via a device communication channel. The at least one smart device contains, i.e., it has stored in it either permanently or for a certain period of time, authorized user credentials and authorized user profile for the user that is the user interaction area.

The microcontroller of the environment control device is configured to trigger at least one personalized function, i.e., a function that is personalized for the user. The personalized function involves the device and is triggered upon establishing authorized user smart presence in the user interaction area. Authorized user presence is established based on verification of the authorized user credentials and further upon a user detection from the thermal imaging performed by the thermal viewer and at least one other user detection that can be ascertained from at least one other sensor and/or imager such as from optical imaging performed by the at least one optical viewer, from proximity sensing performed by the at least one proximity sensor, and from audio sensing performed by the at least one audio sensor.

According to the invention, a continued user presence in the user interaction area or the user's presence in a still further user interaction area within the supervised environment is monitored with precedence given to the thermal imaging. In other words, after establishing authorized user presence in the user interaction area first, subsequent or continued user presence in the user interaction area is monitored by giving priority to thermal imaging. Similarly, priority is given to thermal imaging in establishing user presence in another or further user interaction area within the supervised environment. In other words, the supervised environment can have many user interaction areas which are all monitored with precedence given to thermal imaging upon at first establishing authorized user presence in the user interaction area.

The environment control network is designed around the preferences of the user. Thus, once authorized user presence is established in the user interaction area, the network will perform functions for the user. To achieve that, the microcontroller is configured to issue an executable instruction to the at least one smart device once that smart device reports a certain status to the microcontroller via the device communication channel. The executable instruction and the status depend on the type of smart devices. Exemplary smart devices can be embodied by audio equipment, video equipment, a smart phone, a computer, a temperature sensor, a fan, a heater, a door entry unit, a smart TV, an HVAC system, a smart appliance, lighting, smart furniture, smart window curtains, a pool heater, an irrigation unit, a smart garden device, a smart gate entry, a home security surveillance device, a smart power switch and the like. Thus, depending on the smart device, the executable instruction can be as simple as an “turn on” or “turn off” instruction, or a more complex instruction involving the performance of some specific function for the user, e.g., setting a certain lighting, playing a certain media, adjusting the temperature and/or performing any other function for the user that can be based on the user's preferences and/or comfort requirements.

Some such smart devices as well as the environment control device itself can have an indicator unit to indicate information to the user. In some cases, the indicator unit may simply report that the certain status upon which the executable instruction is to be issued by the microcontroller is satisfied or met. Whatever the type of information to be indicated, it can be intended for the user to view, hear or perceive in any other convenient manner. For example, the indicator unit is a light emitting diode that gives a visual indication or it is an audio unit that gives an audio indication of the status.

The certain status upon which the microcontroller is to issue the executable instruction to at least one smart device occurs in the supervised environment. This certain status can thus be obtained through any combination of imaging and sensing capabilities that the environment control network possesses. For example, detection of the certain status can originate from any combination of thermal imaging, optical imaging, proximity sensing and audio sensing performed by the corresponding imagers and sensors.

Many embodiments of the environment control network are possible. Many of the embodiments are dictated by the type of supervised environment in which the environment control network is deployed. For example, in certain supervised embodiments the device communication channel can be WiFi or Bluetooth such as Bluetooth 5. When shorter distances are involved but a large number of devices are present in environment control network, low-power device communication channels are possible such as Zigbee.

In some embodiments the environment control network may use additional resources to aid in executing its functions and accommodating the user. For example, a machine learning module can be connected to the environment control device to aid in learning patterns, e.g., patterns of user behavior, and appropriate modifications to any of the network's functions.

In some embodiments a separate memory can be provided for storing and dispensing important or sensitive information. For example, the memory can be in communication with the microcontroller and it can contain the authorized user credentials and authorized user profile that are used for verification of authorized user.

The details of the invention will now be addressed in the detailed description and with reference to the drawing figures.

### BRIEF DESCRIPTION OF THE DRAWING FIGURES

FIG. 1A is a three-dimensional diagram of an environment control network with an environment control device deployed in a room

FIG. 1B is a diagram illustrating the main elements of the environment control device of FIG. 1A

FIG. 2 is a diagram that illustrates the operation of the environment control network of FIG. 1A deploying the environment control device shown in more detail in FIG. 1B

FIG. 3A is a three-dimensional diagram of another environment control network deployed in a different supervised environment and deploying alternative resources

FIG. 3B is a three-dimensional diagram of the environment control network as deployed in FIG. 3A using an advantageous embodiment of an environment control device mounted on the ceiling

FIG. 4 is a top view schematic diagram of still another environment control network deployed in a larger supervised environment that covers a number of user interaction areas separate environment control devices

FIG. 5 is a top view schematic diagram of yet another environment control network deployed in an industrial supervised environment

FIG. 6A is a perspective diagram illustrating thermal imaging for a safety application in one area of the industrial supervised environment of FIG. 5

FIG. 6B is a top view schematic illustrating thermal imaging in the safety application introduced in FIG. 6A

FIGS. 7A-B are top view diagrams illustrating thermal imaging for another safety application in an area of the industrial supervised environment of FIG. 5.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

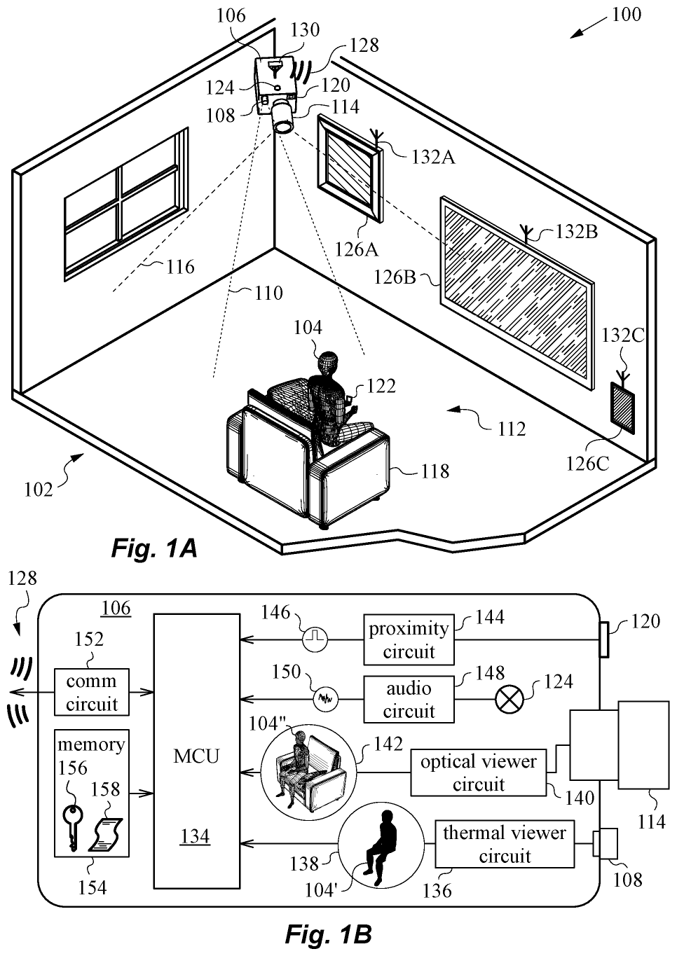

FIG. 1A illustrates a three-dimensional diagram of an environment control network 100 deployed in a simple indoor supervised environment 102. Example supervised environment 102 is a home environment and more precisely a room in the house of a user 104. Only the most important aspects of environment control network 100 are shown in the present embodiment in order to focus on the salient parts.

Environment control network 100 has an environment control device 106 mounted in a top corner of room 102 and equipped with elements and affordances for monitoring room 102. Specifically, environment control device 106 has a thermal viewer 108 that has a field of view 110, hereafter referred to as thermal field of view, within which it can detect entities that emit radiation in the infrared. It should be noted that although viewing often implies that an actual image is produced by thermal viewer 108, it is not absolutely necessary for thermal viewer 108 to image objects in thermal field of view 110. In other words, thermal viewer 108 can use non-imaging optics which do not actually produce an image in an image plane. What is important, however, is that thermal field of view 110 cover or be trained on a certain part of supervised environment 102, i.e., of room 102, where user 104 is expected to be found. This important part of room 102 is referred to herein as a user interaction area 112.

Environment control device 106 also has at least one optical viewer 114 whose visual field of view 116 is set to perform optical viewing of user interaction area 112. Once again, although in most cases optical viewer 114 will actually produce an image of objects in its visual field of view 116, imaging is not strictly required by environmental control network 100. In other words, non-imaging optics/systems can be deployed by optical viewer 114.

It should be noted that both thermal field of view 110 of thermal viewer 108 and visual field of view 116 of optical viewer 114 are trained on user interaction area 112. In the present example embodiment, thermal field of view 110 is smaller than visual field of view 116, yet they overlap in user interaction area 112. Depending on the optics of thermal viewer 108 and optical viewer 114 there may be a complete or almost complete overlap between thermal field of view 110 and visual field of view 116. However, such large degree of overlap is not required, as long as the overlap is sufficient. Specifically, the overlap needs to cover user interaction area 112 such that user 104 can be viewed by both thermal viewer 108 and optical viewer 114.

In the present embodiment user interaction area 112 is centered about a frequently used piece of furniture 118, specifically an armchair in which user 104 is often seated. In general, however, interaction area 112 can be much larger and it can even span or include entire supervised environment 102, which in the present case is room 102.

Environment control device 106 is also equipped with a proximity sensor 120 for object proximity sensing within the user interaction area 112. Specifically, proximity sensor 120 can sense an object 122 associated with user 104 or may even directly sense user 104. In the present case object 122 whose proximity is sensed is a smart phone belonging to user 104. Alternatively, object 122 can be a smart watch, a wrist band, a wearable item or some other accoutrement that user 104 finds convenient. To expedite proximity sensing, object 122 should have a suitable built-in sensing technology, e.g., an RFID circuit or other proximity sensing technology.

Further, environment control device 106 has an audio sensor 124 for picking up sounds or audio sensing within user interaction area 112. Suitable audio sensor 124 can be a microphone that detects/receives acoustic waves or sound waves in user interaction area 112. It should be noted that the acoustic spectrum covered by audio sensor 124 can either overlap or extend beyond the spectrum that is audible to user 104.

Environment control network 100 has several smart devices 126A, 126B, 126C in communication with environment control device 106. It will be appreciated that many types of smart devices can be deployed within environment control network 100. The choice of such smart devices is typically dictated by the type of supervised environment 102 as well as the intended uses of environment control network 100. Thus, in general, smart devices can be embodied by audio equipment, video equipment, a smart phone, a computer, a temperature sensor, a fan, a heater, a door entry unit, a smart TV, an HVAC system, a smart appliance, lighting, smart furniture, smart window curtains, a pool heater, an irrigation unit, a smart garden device, a smart gate entry, a home security surveillance device, a smart power switch and the like. In the present exemplary environment control network 100 as shown in FIG. 1A and deployed in room 102 smart devices 126A, 126B, 126C are represented by a smart picture display, a smart TV and a heater, respectively.

Environment control network 100 requires support for communications between environment control device 106 and smart picture display 126A, smart TV 126B and heater 126C. To accommodate this requirement a device communication channel 128 exists between environment control device 106 and devices 126A, 126B, 126C. Communication channel 128 is a wireless channel and is supported by corresponding communications units 130 in control device 106 and 132A, 132B, 132C in devices 126A, 126B, 126C, respectively.

FIG. 1B is a diagram of environment control device 106 that shows its main elements in more detail. Specifically, environment control device 106 has a microcontroller 134 (MCU) that orchestrates the operation of environment control device 106 and of environment control network 100. A suitable microcontroller 134 capable of managing all envisioned functions and features can be embodied by a suitable microprocessor such as the Xtensa dual-core 32-bit LX7 microprocessor that operates at clock speeds up to 240 MHz and is supplied by Tensilica. It is noted that microcontroller 134 must have sufficient memory to fulfill its duties and the Xtensa dual-core 32-bit LX7 is advantageous because it provides 384 KB ROM, 512 KB SRAM, 16 KB SRAM in RTC and up to 8 MB PSRAM.

Microcontroller 134 is connected to thermal viewer 108, and more precisely to its associated thermal viewer circuit 136. In the present case, thermal viewer 108 does perform imaging and thus thermal viewer circuit 136 provides a thermal image 138 of objects in its thermal field of view 110. Since user 104 is within thermal field of view 110 that covers user interaction area 112 (see FIG. 1A), thermal image 138 contains a thermal user image 104′.

Microcontroller 134 is also connected to optical viewer 114, and more precisely to its associated optical viewer circuit 140. Preferably, optical viewer circuit 140 supports both remote video capture as well as video recording. In the present case, optical viewer 114 does perform imaging and thus optical viewer circuit 140 provides an optical image 142 of objects in its optical field of view 116. Since user 104 is within optical field of view 116 that covers user interaction area 112 (see FIG. 1A), optical image 142 contains an optical user image 104″.

Microcontroller 134 is further connected to proximity sensor 120, and specifically to its associated proximity sensing circuit 144. Based on detection of proximity of user 104 and/or of user's device such as smart phone 122 (see FIG. 1A), proximity sensing circuit sends a corresponding proximity read 146 to microcontroller 134. When sensing user 104, proximity sensing circuit 144 can additionally distinguish or detect hand or body gestures that user 104 can execute. Such gestures/actions can be useful in the personalization of the functions performed by environment control network 100.

Additionally, microcontroller 134 is connected to audio sensor 124 via audio circuit 148 of audio sensor 124. Audio sensor 124 delivers to microcontroller 134 via audio circuit 148 an audio signal 150 that it picks up or detects in user interaction area 112 (see FIG. 1A). Preferably, audio sensor 124 operates via an I2S audio analog controller serial interface. Such system is capable of both sensing audio signal 150 in user interaction area 112 as well as producing audio output, e.g., to produce audio alerts or warnings intended for user 104. When detecting audio signal 150 audio circuit 148 can additionally distinguish or detect certain types of sounds. For example, the sounds may be generated by user 104 and they may include clapping of hands or spoken/voice commands. Such audio sensing capabilities can be useful in the personalization of the functions performed by environment control network 100.

To support the necessary communications, microcontroller 134 has a communications circuit 152 that supports communications via communications channel 128. As mentioned above, communications channel 128 is wireless and preferably short-range; e.g., WiFi or Bluetooth. Communications circuit 152 is thus either WiFi or Bluetooth and supports bi-directional communication on communications channel 128. Suitable WiFi circuitry can be embodied by WIFI 802.11 b/g/n controller interface that supports remote access, control, management, data gathering and product feature functionality. Suitable Bluetooth circuitry can be embodied by Bluetooth LE: Bluetooth 5, Bluetooth mesh. It should also be noted that in certain supervised embodiments that are sufficiently small communication channel 128 can take advantage of shorter distances involved, especially if a large number of devices are present in environment control network, by using a low-power device communication channels such as Zigbee.

In the present case the use of Bluetooth is preferred. This is particularly advantageous in identifying user 104 in interaction area 112. Bluetooth is also capable of controlling other Bluetooth enabled smart devices nearby. This is particularly advantageous when smart devices 126A, 126B, 126C are themselves Bluetooth enabled smart devices and support remote control of their various operational modes and functionalities.

In the present embodiment environment control device 106 also has a separate memory 154 that is connected to microcontroller 134. Separate memory 154 is preferably designed with appropriate affordances, e.g., hardening, to protect sensitive data. Such sensitive data typically includes authorized user credentials 156 that are used for verification of authorized user in user interaction area 112 (see FIG. 1A). In addition, memory 154 contains authorized user profile 158 that includes user preferences. Authorized user credentials 156 and authorized user profile 158 can be stored in memory 154 permanently or just for a certain period of time.

Microcontroller 134 of environment control device 106 is configured to trigger at least one personalized function, i.e., a function that is personalized for user 104 once certain conditions are met. The personalized function or functions involve at least one of smart devices 126A, 126B, 126C. The conditions and personalized functions as well as continued presence of user 104 in room 102 and in user interaction area 112 are all monitored with precedence given to thermal imaging. That is, upon first establishing authorized user presence in user interaction area 112 thermal imaging is given precedence in environment control network 110.

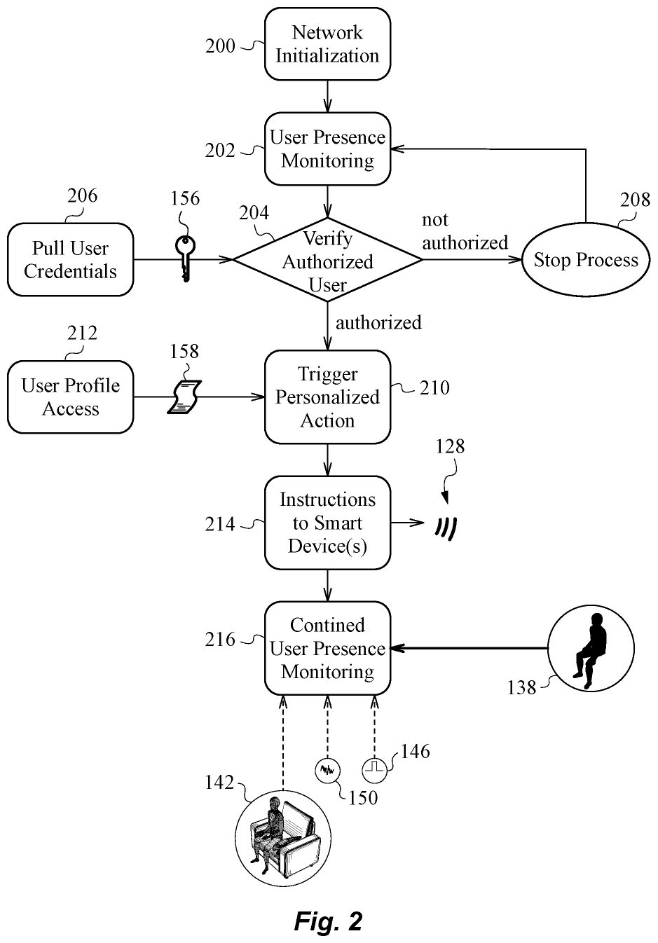

FIG. 2 is a diagram illustrating the operation of environment control network 100 in room 102 as shown in FIGS. 1A-B according to the conditions, the personalized functions and the precedence rule. At first environment control network 100 is initialized at step 200. This step includes any typical start-up processes and tests and occurs on all elements of network 100 including environment control device 106 as well as smart devices 126A, 126B, 126C and circuits supporting communication channel 128. Preferably, network 100, once initialized, can operate for long periods of time without requiring re-start and re-initialization. Since only one single environment control device 106 is used in this simple example, this same environment control device 106 is given administrative rights and priority. In more complicated networks where a number of control devices are used the start-up process also typically involves assignment and confirmation of administrative rights and priority.

During operation environment control network 100 continuously monitors for user presence in user interaction area 112 as indicated in user presence monitoring step 202. Any of sensing elements belonging to network 100 can be used to determine presence of user 104 in user interaction area 112 during step 202. In other words, user 104 can be detected as present based on thermal image 138, optical image 142, audio signal 150 or proximity read 146. Proximity read 146 can be obtained based on the presence in user interaction area 112 of a user article or object, e.g., phone 122 or of user 104.

Once user 104 is detected in interaction area 112 a verification step 204 is performed to establish authorized user presence. In other words, user 104 has to pass verification step 204 before environment control network 100 makes any further functions available to user 104. In the present embodiment, verification step 204 checks or pulls in a separate authentication step 206 authorized user credentials 156 from memory 154.

If user 104 is not authorized, then the verification process is terminated at step 208 and network 100 returns to previous step of user presence monitoring 202 for a user that is authorized. Depending on whether network 100 has a security feature that was previously turned on by an authorized user, security protocols may be executed such that environment control device 106 (or other such devices in network 100 when the network has a number of devices or nodes) may issue home invasion warnings to scare off intruders or request for the individual who has gone into the area without permission to identify themselves. On the other hand, if user 104 is established as authorized user during verification step 204 and based on credentials 156 gathered in step 206 then the process continues.

Upon establishing authorized user presence in user interaction area 112 during verification step 204 and based on user presence determined in step 202 the process continues to a triggering step 210. Triggering step 210 relies on user profile 158 pulled from memory 154 in a separate user profile accessing step 212. Specifically, one or more personalized actions are derived in triggering step 210 based on user profile 158. Profile 158 may additionally include user priorities. For example, if user 104 is a parent then they will have a higher priority than a child. Among parents, one may have a higher priority than the other and thus supersede everyone in room 102. On the other hand, children may have the highest priority if room 102 is actually their room.

In the present example, personalized actions involve displaying user selected photographs on smart picture display 126A, turning on and tuning smart TV 126B to user's favorite channel and setting heater 126C to user's preferred temperature. These personalized actions are converted into corresponding instructions for smart devices 126A, 126B, 126C in step 214. The instructions are transmitted to smart devices 126A, 126B, 126C via communications channel 128, as indicated in the diagram of FIG. 2. The triggering personalized actions in step 210 and the issuing corresponding instructions in step 214 are performed by environment control device 106.

In accordance with the invention, the operation of network 100 is predicated on further checking or monitoring for continued user presence in user interaction area 112. In other words, after initially establishing authorized user presence in user interaction area 112 and performing the above steps the process passes to a step 216 of monitoring for continued user presence in interaction area 112. It is important that step 216 give priority or precedence to thermal viewing or imaging performed by thermal viewer 108. In other words, continued user presence is established from thermal image 138. This continued user presence can be further corroborated from optical image 142, proximity read 146 and/or audio signal 150, as indicated. However, these viewer and sensor inputs are not considered unless thermal image 138 first determines continued user presence.

The advantage of giving precedence to thermal image 138 when monitoring continued user presence in step 216 derives from the fact that user 104 may perform actions that impair other viewer and sensor inputs. For example, user 104 may turn off the lights in room 102 thus impairing optical image 142. Similarly, user 104 may turn off or put away phone 202 or other wearable object, thus thwarting the ability to obtain proximity read 146. Also, user 104 may stop moving and remain silent, thus defeating the ability of obtaining any useful information from audio signal 150. On the other hand, thermal image 138 does not rely on these viewing and sensing modalities since thermal user image 104′ is a biometric of user 104.

In the present simple embodiment that focuses on the most salient features of the invention environment control network 100 is limited to a single user interaction area 112 within a single supervised environment, namely room 102. Furthermore, all smart devices 126A, 126B, 126C in this embodiment are also located in room 102. However, much larger environment control networks with many user interaction areas and types of smart devices, some of which may be remote are possible. In addition, other network configurations and task distributions between devices that are local or even remote are also possible.

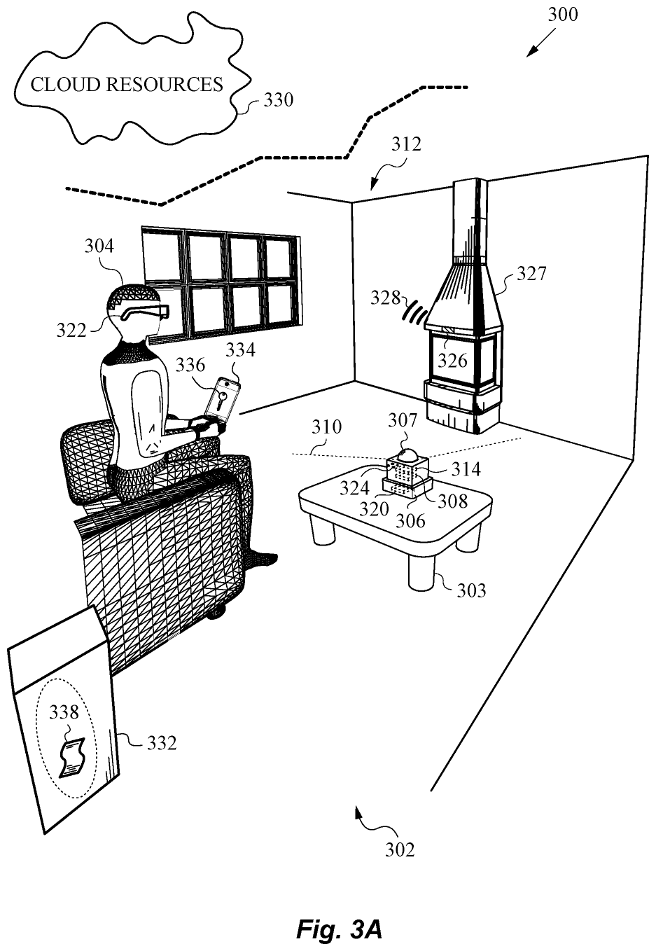

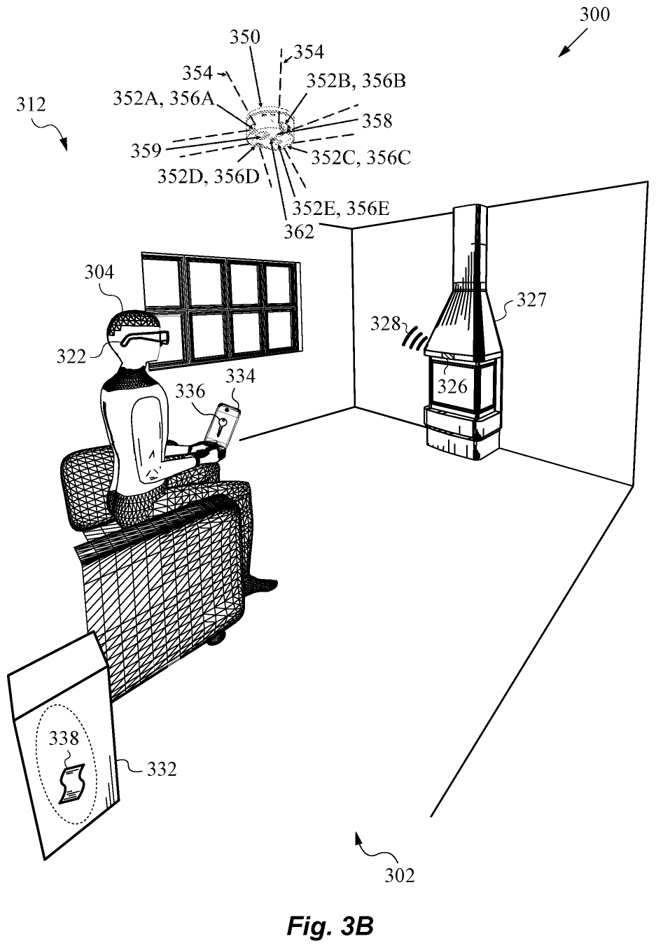

FIG. 3A shows another environment control network 300 deployed in a supervised environment 302 which is a living room of a user 304. Environment control network has an environment control device 306 that is placed in the center of living room 302 on a table 303. It should be noted that in this embodiment environment control device 306 can actually be placed by user 304 at any convenient central location in living room 302. Indeed, it could even be mounted facing down on the ceiling of living room 302. That is because environment control device 306 has an omnidirectional lensing system 307. A field of view 310 of lensing system 307 is 360 degrees around and 180 degrees in altitude, also sometimes referred to as 360 by 180 view by those skilled in the art. In many environment control networks according to the invention this type of environment control device 306 and the 360 by 180 lensing system 307 are preferred.

Environment control device 306 has an internally mounted thermal viewer 308 indicated schematically with dashed lines. A thermal field of view of thermal viewer 308 coincides with field of view 310 of omnidirectional lensing system 307. In other words, thermal field of view is field of view 310 afforded by omnidirectional lensing system 307 and it covers a user interaction area 312 with a 360 by 180 view.

Environment control device 306 also has an optical viewer 314 mounted internally and indicated schematically with dashed lines. An optical field of view of optical viewer 314 also coincides with field of view 310 of omnidirectional lensing system 307. In other words, optical field of view is field of view 310 afforded by omnidirectional lensing system 307 and it covers user interaction area 312 with its 360 by 180 view, just as in the case of thermal viewer 308 and its field of view.

Further, environment control device 306 has a proximity sensor 320 mounted internally and indicated schematically with dashed lines. Proximity sensor is also arranged to sense events within user interaction area 312 and preferably over a region that is co-extensive with field of view 310. Proximity sensor 320 is designed for sensing objects associated with user 304 and/or for sensing user 304. A Time-of-Flight (ToF) multizone ranging sensor with diffractive optical elements (DOEs) is one type of suitable sensor for use as proximity sensor 320. Another type sensor that can be used is a combination of infrared and/or optical unit sensor set up for proximity sensing.

More specifically still, proximity sensor 320 is designed to sense distances to body parts of user 304 such as hands, arms or body so as to determine gestures that user 304 may perform during operation. Also, in the present case a wearable object, more specifically glasses 322 that user 304 wears are to be sensed by proximity sensor 320. It is understood that user 304 may need to approach device 306 while wearing glasses 322 if the proximity sensing technology employed is short-range.

Still further, environment control device 306 has an audio sensor 324 for picking up sounds or audio sensing within user interaction area 312. Audio sensor 324 is also indicated schematically inside environment control device 306 with dashed lines.

Note that in this preferred embodiment of environmental control device 306 all of its components can be packaged into a standard-size smoke alarm system to make it more convenient for user 304 to place and/or mount. This is particularly convenient for user 304 when environment control network 300 extends over a large user interaction area 312 or over a number of user interaction areas, as is the case in the embodiments below.

Environment control network 300 has a single smart device 326 in communication with environment control device 306. In the present example, smart device 326 is a control unit mounted on a fireplace 327. Smart device 326 is capable of turning fireplace 327 on and off as well as regulating its gas supply. Control unit 326 is provided with a wireless communications channel 328 to support communications with environment control device 306.

As in the previous embodiment, environment control device 306 has a microcontroller (not shown), that is configured in a manner similar to the configuration shown in FIG. 1B. However, in the present embodiment environment control device 306 also cooperates with cloud resources 330 that are remote and with a home computer 332 located in living room 302. Furthermore, environment control device 306 also communicate with another object 334 associated with user 304, here embodied by a tablet. It should be noted that presence of tablet 334 established over communications channel 328 or another communications channel can be used in this embodiment to establish user presence provided user 304 is also thermally sensed.

The operation environment control network 300 is similar to the operation of network 100 described in reference to FIGS. 1A-B, but with a few changes. Specifically, authorized user credentials 336 and user profile 338 are not stored in environment control device 306. Instead, authorized user credentials 336 are stored on tablet 334 while user profile 338 is stored on home computer 332.

In this embodiment, user 304 may use additional safety features during authentication. For example, user may use additional biometrics, such as fingerprint authentication or face-based authentication by a back camera of tablet 334. Furthermore, the presence of user profile 338 as well as preferences and priorities on home computer 332 is advantageous because it affords user 304 more updating options. Also, the connection to cloud resources 330 permits the application of more advanced functions.

The present embodiment is well-suited for the use of machine learning. In particular, a machine learning algorithm can be installed on home computer 332 or it can be located in cloud resources 330. Indeed, cloud resources 330 can have machine learning algorithms available as a cloud service. An advantage of cloud resources 330 is access of high-performance services that may provide better machine learning that can be performed locally on home computer 332.

In general, machine learning will adapt to the priorities and preferences of user 304 based on the settings user 304 selects as well as daily and past activities. These may be used to determine actions within user interaction area 312.

Although FIG. 3A illustrates only one environment control device 306 being deployed, in many cases a number of them will be deployed in a network that is distributed throughout supervised area 302. In such cases we refer to each environment control device 306 as a node since it is a part of a larger network. When a number of nodes are present additional steps become important, such as choosing the master node with administrative rights and the slave or support nodes.

Furthermore, FIG. 3B illustrates environment control network 300 that deploys an environment control device 350 that is mounted on the ceiling of living room 302. In many applications environment control device 350 that is ceiling-mounted is actually preferred. Environment control device 350 has multiple lensing systems 352A, 352B, 352C and 352D that constitute a joint lensing system that provides a joint field of view 354. Field of view 354 is 360 degrees around and 180 degrees in altitude, also sometimes referred to as 360 by 180 view by those skilled in the art. Environment control device 350 also has multiple proximity and distance sensors 356A, 356B, 356C and 356D with a combination of infrared and/or optical sensing units. Further, environment control device 350 an audio sensor 358 for audio sensing and a smoke/CO₂/air quality sensor 362 for home safety awareness. Environment control device 350 uses a speaker 359 for audio warning or for entertainment.

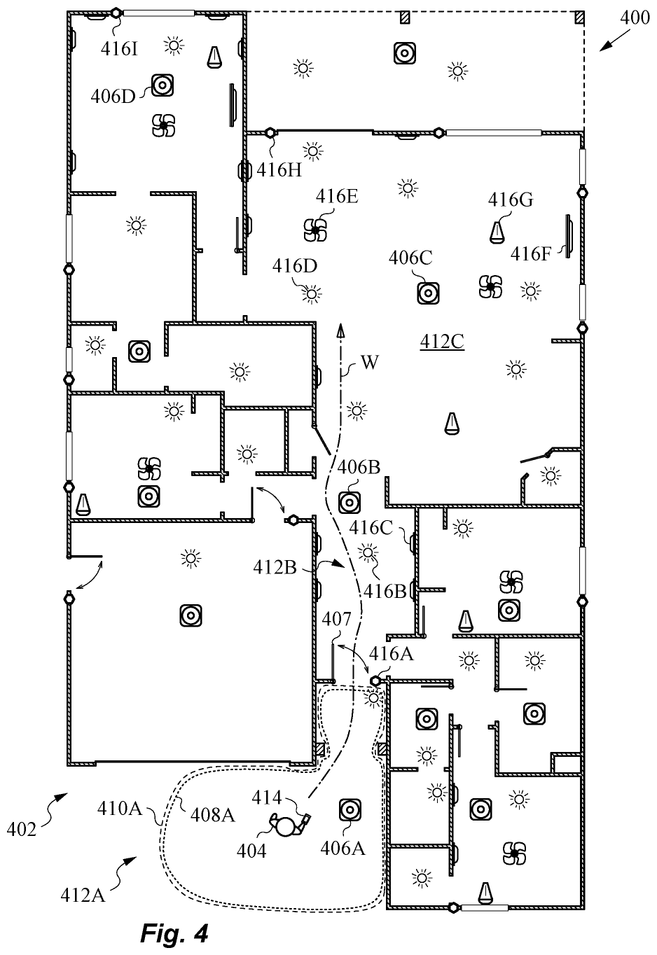

FIG. 4 is a top view schematic diagram of another environment control network 400 deployed in a much larger supervised environment 402. The large network coverage area does not change the thermal detection precedence described in the above embodiments but it does require a number of additional control devices and proper management of their operation. In the example shown here network 400 covers an entire house and outdoor areas in front of the house and behind it as well.

Environment control network 400 has a number of environment control devices 406, of which only control devices 406A, 406B, 406C and 406D are explicitly referenced in FIG. 4 for reasons of clarity. Note that control devices 406 are here referred to as nodes in the context of network 400, as will be appreciated by those skilled in the art. In the present case nodes or control devices 406 can be embodied by units similar to environmental control device 306 described above that has all of its components packaged into a standard-size smoke alarm system unit that is convenient for user 404 to place and/or mount.

It should also be noted that a hierarchy is present among nodes 406 with select nodes being master nodes with administrative rights and other nodes being slave or servant nodes. A hierarchy is indeed necessary in large supervised environments where more than one control device 406 is present in the same part or area of supervised environment 402. In the present example node 406A is selected as the master node with administrative rights, while remaining nodes 406 distributed at various locations throughout supervised environment 402 are servant nodes.

A user 404 is shown in FIG. 4 approaching and about to enter house 402. To follow the operation of network 400 we follow the progress of user 404. At the instant illustrated in FIG. 4, user 404 is just outside a front entry door 407. This area is under supervision by environment control device 406A which is also the master node that is located in front of entry door 407 on a front porch. Control device 406A is mounted high off the ground, e.g., under a roof or awning, or it may be simply mounted to a wall of house 402. Environment control device 406A is equipped with a thermal viewer, an optical viewer, a proximity sensor and an audio sensor. These elements are not explicitly shown in FIG. 4, but they are analogous to those described in previous embodiments and shown in more detail in FIGS. 1A-B.

Thermal viewer of control device 406A has a thermal field of view 408A and optical viewer belonging to it has a visual field of view 410A. Both thermal and visual fields of view 408A, 410A cover a substantial portion of a first user interaction area 412A. In fact, thermal and visual fields of view 408A, 410A largely overlap within user interaction area 412A since the preferred embodiment with a 360 by 180 field of view on user interaction area 412A is deployed in this embodiment.

User 404 has a smart device 414 that has stored on it authorized user credentials and authorized user profile (not shown). The authorized user credentials and profile serve the same functions and are used by network 400 in the same manner as described above. In particular, once user 404 enters user interaction area 412A that is supervised by environment control device 406A the user credentials are used for verification. When user credentials are verified in conjunction with detection of user 404 in thermal field of view 408A by the thermal viewer and also detection of user 404 by at least one other viewer or sensor of control device 406A then authorized user presence in user interaction area 412A is considered established.

At this point, control network 400, and more specifically control device 406A triggers a personalized function for user 404 based on the user profile. We note that network 400 has a number of smart devices 416 that can be instructed to perform one or more personalized functions for user 404. In the present example only smart devices 416A, 416B, 416C, 416D, 416E, 416F are explicitly labeled for reasons of clarity. Additional smart devices 416 can be seen at different locations in house 402.

In the present example, upon establishing authorized user presence, control device 406A that is the master node sends instructions to smart device 416A, which is a door entry unit, to trigger a first personalized function, namely to open front door 407 for user 404. Once inside, door entry unit 416A closes front door 407 and user 404 moves along a path indicated by dashed and dotted arrow W into interaction area 412B.

The location of user 404 within supervised area 402 is continuously monitored by master node 406A. This includes determining the travel direction of user 404 to determine when control should be released to node 406B in the hallway. In other words, if user 404 has walked into the home node 406A can detect this and hand over control to the next node. In the present case user 404 passes from user interaction area 412A to user interaction area 412B. User interaction area 412B covers the hallway and front part of the living room and it is monitored and controlled by control device 406B mounted to the ceiling at the end of the hallway. Once user 404 is in the hallway control device 406B that plays servant role is promoted by master node 406A and placed in charge.

While user 404 is within user interaction area 412B control device 406B triggers additional personalized functions. First, control device 406B instructs smart device 416B, which is a smart lighting unit, to turn on the light to a level that user 404 prefers (based on aforementioned user profile). Second, control device 406B instructs smart device 416C, which is a smart picture frame, to display favorite pictures and/or photographs of user 404. Digital picture frame 416C may be connected to a social network or media server, such as Facebook, Twitter, or to a storage device with various available pictures from the user's 404 past trips/vacations. Depending on the day, pictures can flash on the digital smart frames base on 1 year anniversaries, past year vacation trips, favorite hobbies, favorite movies, or most popular browsed topic that day.

As user 404 proceeds along path W they pass into interaction area 412C that covers the living room and is under the supervision of control device 406C. Once hand-off from control device 406B to control device 406C occurs the latter triggers additional personalized functions for user 404. Specifically, control device 406C issues commands to smart device 416D, which is another smart lighting unit, to turn on the light and also instructs smart device 416E, which is a smart fan, to turn at a rate that is adapted to suit user 404. Further, control device 406C instructs smart TV 416F to turn on and switch to the user's 404 favorite TV series. Still other smart devices 416G, 416H represented by audio equipment and smart gate entry to the back porch can also be controlled by control device 406C.

House 402 has a further environment control unit 406D in the user's 404 bedroom to control smart devices that operate there. Such devices can include smart window curtains 4161 and still other smart devices 416. It should be noted that smart devices 416 in regions of house 402 that are supervised by still other control units 406 can be turned on and off as well. FIG. 4 illustrates a number of such additional regions with control units and smart devices that are not explicitly referenced. It will be apparent to a person skilled in the art that smart devices 416 deployed in house 402 can be embodied by many different types of audio equipment, video equipment, a smart phone, a computer, a temperature sensor, a fan, a heater, a door entry unit, a smart TV, an HVAC system, a smart appliance, lighting, smart furniture, smart window curtains, a pool heater, an irrigation unit, a smart garden device, a smart gate entry, a home security surveillance device, a smart power switch and the like. Thus, depending on smart device 416, the executable instruction can be as simple as an “turn on” or “turn off” instruction, or a more complex instruction involving the performance of some specific function for user 404, e.g., setting a certain lighting, playing a certain media, adjusting the temperature and/or performing any other function for user 404 that can be based on the user's preferences and/or comfort requirements.

Network 400 can also take advantage of additional direct input from user 404. For example, the proximity sensors in nodes 406 can be used to recognize hand or body gestures executed by user 404. Such gestures can be assigned to certain functions or commands by authorized user 404 within the area supervised by the corresponding node 406. Likewise, audio sensors in nodes 406 can be used to recognize voice commands of hand clapping by user 404. Such voice commands can be assigned to certain functions or commands available to authorized user 404 within the area supervised by the corresponding node 406.

In accordance with the invention, continued user presence of user 404 in one of user interaction areas 412 is monitored by network 400 at all times. As described above, in monitoring continued user presence network 400 gives precedence to thermal viewing or thermal imaging performed by the thermal viewer of the corresponding control device 406.

The present embodiment can take advantage of machine learning algorithms as well. Once again, the machine learning should adapt to the priorities and preferences of user 404 to determine actions within each interaction area 412. The adaptation is based on preferred settings, daily and/or past activity, as well as any other indications gathered from user 404. The machine learning algorithm can thus make informed choices about turning smart TV 416F on or off in living room 412C and operate smart fan 416E based on learned patterns.

Preferably, each area or room 412 has a priority list that determines who has higher priority than others, since not only user 404 but also other users, e.g., family members can be present in house 402. If user 404 is a parent or manager of any given supervised area 406 in house 402, the environment settings will be prioritized for that individual rather than children or employees.

Further, when machine learning is deployed, smart features that include smart learning for nodes 406 in any particular area 412 are activated. For example, in the case of area 412C that includes the kitchen the machine learning algorithm can determine when a fire or stove (gas or electric) is still on. When user 404 is still in the kitchen or nearby, then node 406 in the kitchen does not issue any safety warning. However, as soon as every user within that area is gone for a certain amount of time while a stove is still on or if there is an open flame/fire, user 404 is notified of potential hazard. Of course, user 404 may choose to ignore the warning by indicating that the fire is just a candle or that the hot pot needs to be left on. Such indications by user 404 are then used by the machine learning algorithm to improve pattern understanding for the future.

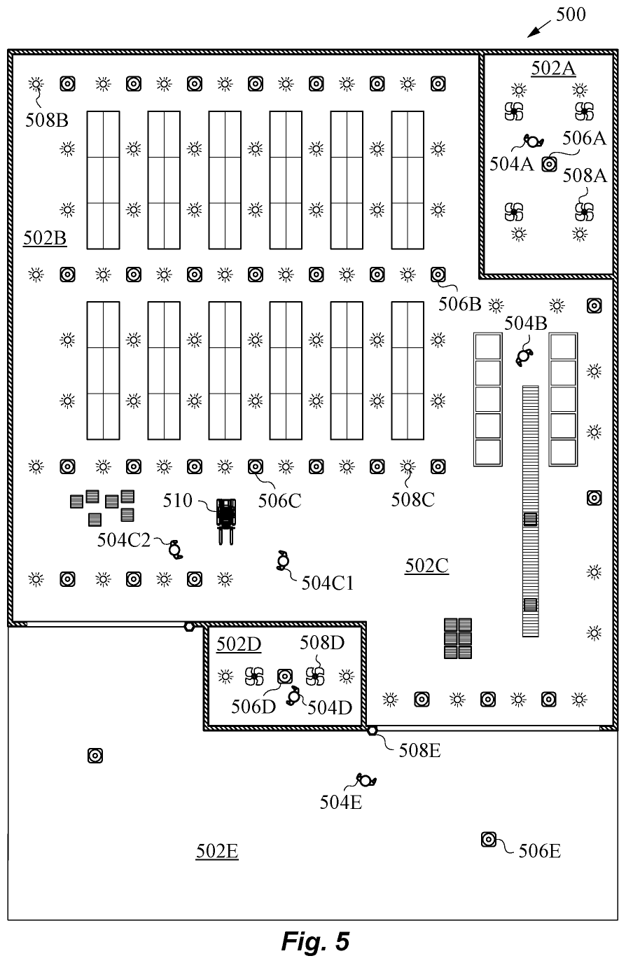

FIG. 5 is a top view schematic diagram of still another environment control network 500 deployed in an industrial or work environment 502 that is embodied by a work facility. In the example shown here, network 500 covers entire work facility 502 that has a central office 502A, a storage area 502B, a distribution center 502C, a lounge 502D and loading docks 502E. Just a few representative users 504, namely workers 504A, 504B, 504C1, 504C2 504D and 504E are shown in each area of facility 502.

The large network coverage area does not change the thermal detection precedence described in the above embodiments but it does require a larger number of control devices 506 and proper management of their operation. For reasons of clarity only a few control devices 506A, 506B, 506C, 506D and 506E are expressly labeled in FIG. 5. Preferably an established perimeter is automatically set up by a software setup that manages and operates environment control network 500. In the present example perimeters or blocks are established in central office 502A, storage area 502B, distribution center 502C, lounge 502D and loading docks 502E. Each block or perimeter has at least one control device 506 mounted in it. In blocks where many control devices 506 are provided a single one of them is selected as the master device. In fact, the previously called out control devices 506A, 506B, 506C, 506D and 506E are masters in their corresponding blocks.

The setup software that allows for setting different blocks or perimeters can be used in any environment, including a work environment, a recreational facility, a public facility, a private establishment or a home environment, e.g., as described above in the embodiment of FIG. 4. In the present example, the setup software allows users 504 access to a building block of control devices 506, often referred to as nodes. Nodes 506 are defined to here to be in work environment 502, while in other examples the nodes can be defined for other environments such as a home environment. In the present case, user 504 can manipulate, e.g., by a drag and drop operation provided by a user interface with the setup software, the building blocks of nodes 506 in work environment 502. Thus, user 504 drags and drops blocks of nodes 506 in desired areas such as central office 502A, storage area 502B, distribution center 502C, lounge 502D and loading docks 502E. Furthermore, user 504 designates master nodes to be represented by control devices 506A, 506B, 506C, 506D and 506E in their corresponding blocks that belong to areas 502A, 502B, 502C, 502D and 502E, respectively.

Pre-defined area blocks settings are provided with the software application that operates network 500 to enable user environments such as user environment 502 to be set up with simple operations, such as drag and drop options. Of course, the settings can be edited or changed after being dropped or configured for user environment 502. The blocks can be associated with smart notes installed in each one of areas 502A, 502B, 502C, 502D and 502E as well as the corresponding smart devices 508 in each area that nodes 506A, 506B, 506C, 506D and 506E control. Smart notes enable administrator users of network 500 to identify areas as secured, restricted, top secret or hazardous and to confine which areas each node is associated with.

For reasons of clarity only a select few smart devices 508 are called out in FIG. 5. Specifically, smart devices 508A, 508B, 508C, 508D and 508E embodied by a smart fan, a smart light, another smart light, another smart fan and a smart door sensor are called out in areas 502A, 502B, 502C, 502D and 502E. Note that these areas are controlled by nodes 506A, 506B, 506C, 506D and 506E but other nodes that are not expressly labeled yet reside in these areas may control the smart devices 508A, 508B, 508C, 508D and 508E. The proper hierarchy for nodes 506 can be established in accordance with protocols and layouts that are well-known to those skilled in the art.

We now turn to the operation and advantages of environment control network 500 that gives precedence to thermal imaging. First, control network 500 recognizes workers 504A, 504B, 504C1, 504C2 504D and 504E as authorized using any one of its nodes 508 based on verification of worker credentials from thermal imaging and at least one other detection modality, as described in the previous embodiments. Once workers 504A, 504B, 504C1, 504C2 504D and 504E are initially recognized as authorized by environment control network 500, their continued presence in user interaction areas that are parts of supervised environment of facility 502 is monitored with priority given to thermal imaging. This monitoring is managed by master nodes 506A, 506B, 506C, 506D and 506E in each of their assigned areas within facility 502.

We now turn for more details to the operation of control network 500 in distribution center 502C. Distribution center 502C is under supervision of master node 506C. Its smart devices such as smart light 508C as well as other smart devices 508 not expressly called out are set according to personalized functions. At the instant illustrated in FIG. 5 distribution center 502C has two workers 504C1, 504C2 working there. The personalized functions set for workers 504C1, 504C2 include turning smart light 508C and the unlabeled smart lights in distribution center 502C to the appropriate level that is most conducive to their work.

Additional functions that support workers 504C1, 504C2 include monitoring their continued safety. In the present example, this involves control network 500 tracking of a forklift 510 that is being operated in distribution center 502C while workers 504C1, 504C2 are working.

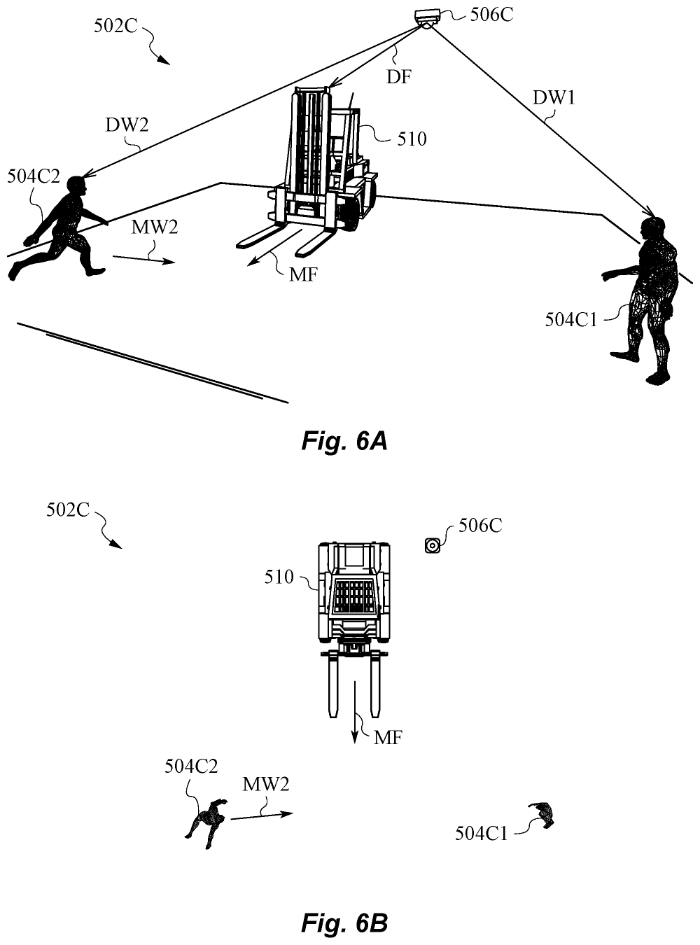

FIG. 6A affords a perspective diagram view of the portion of distribution center 502C where workers 504C1, 504C2 are working while forklift 510 is being operated. At this time master node 506C is using its resources to track the positions as well as movement of forklift 510 and workers 504C1, 504C2. In particular, master node 506C uses its proximity sensor to track the distance to each one of workers 504C1, 504C2 and to forklift 510. The actual distances are designated by arrows DW1, DW2 and DF. The change in distances DW1, DW2 and DF over time allow master node 506C to calculate movement and more specifically velocities. In this case, worker 504C1 is not moving while worker 504C2 is running along direction MW2 and forklift 510 is being driven forward along direction MF.

FIG. 6B is a top view schematic illustrating thermal imaging of the portion of distribution center 502C of FIG. 6A where 504C1, 504C2 and forklift 510 are being monitored. This shows the advantage of thermal imaging, since it can tell apart humans from inanimate objects. In the case of forklift 510 thermal imaging can detect the thermal signature of a human operator inside forklift 510. Although the resolution may be low, e.g., due to overlap and obstruction, it will still yield sufficient accuracy to determine whether forklift 510 is being operated by a human or not.

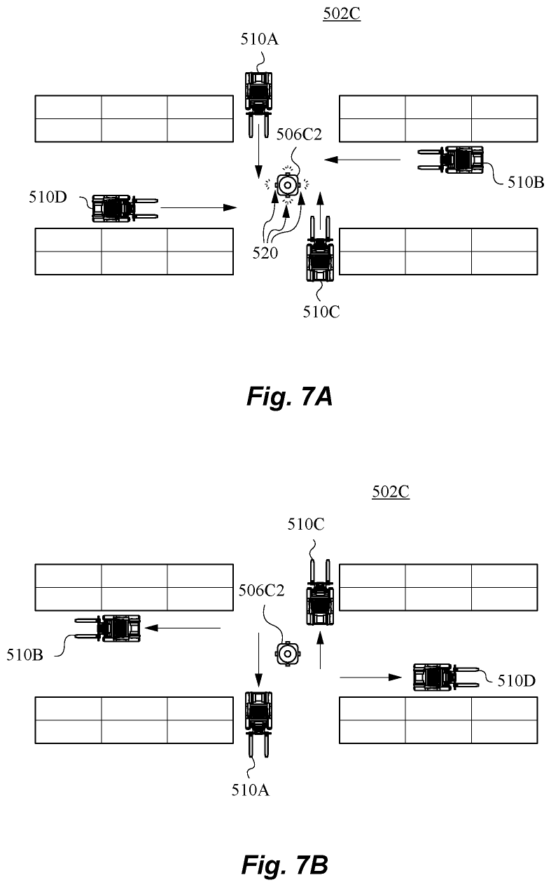

FIGS. 7A & 7B illustrate a portion of distribution center 502C at two points in time. FIG. 7A shows when four forklifts 510A, 510B, 510C and 510D are approaching an intersection. FIG. 7B shows when forklifts 510A, 510B, 510C and 510D have cleared the intersection. A specific smart node 506C2 is supervising an intersection in distribution center 502C at this time. Smart node 506C2 has indicator units 520 in the form of four lights that indicate visual information by flashing. Specifically, in FIG. 7A indicator units 520 all flash to warn forklifts 510A, 510B, 510C and 510D of their mutual approach to the intersection. In FIG. 7B indicator units 520 no longer flash, since forklifts 510A, 510B, 510C and 510D have cleared the intersection.

Many alternative embodiments of the networks and devices are possible. In some embodiments a separate memory can be provided for storing and dispensing important or sensitive information. Such separate memory can have its own safety and security provisions. Given the higher level of security such separate memory can be in communication with the microcontroller and it can contain the authorized user credentials and authorized user profile that are used for verification of authorized user.

Some smart devices as well as the environment control device itself can have an indicator unit to indicate information to the user without relying on any smart devices in the network. In such cases, the indicator unit may simply report that the certain status upon which the executable instruction is to be issued by the microcontroller is satisfied or met. Whatever the type of information to be indicated, it can be intended for the user to view, hear or perceive in any other convenient manner. For example, the indicator unit is a light emitting diode that gives a visual indication or it is an audio unit that gives an audio indication of the status.

In view of the above teaching, a person skilled in the art will recognize that the methods of the present invention can be embodied in many different ways in addition to those described without departing from the principles of the invention. Therefore, the scope of the invention should be judged in view of the appended claims and their legal equivalents.

What is claimed is:

1. An environment control network for controlling a supervised environment, said environment control network comprising:
a) an environment control device having:
1) at least one thermal viewer having a thermal field of view for performing thermal imaging of a user interaction area within said supervised environment;
2) at least one optical viewer having a visual field of view for performing optical imaging of said user interaction area;
3) at least one proximity sensor for proximity sensing within said user interaction area;
4) at least one audio sensor for audio sensing within said user interaction area;
5) a microcontroller connected to said at least one thermal viewer for obtaining a thermal image, and connected to said at least one optical viewer for obtaining an optical image, and connected to said at least one proximity sensor for obtaining a proximity read, and connected to said at least one audio sensor for obtaining an audio signal;
b) at least one smart device in communication with said environment control device via a device communication channel, said at least one smart device containing authorized user credentials and an authorized user profile wherein;
said microcontroller is configured to trigger at least one personalized function involving said smart device upon establishing an authorized user presence in said user interaction area based on verification of said authorized user credentials and upon further user detection from said thermal imaging and at least one of said optical imaging, said proximity sensing and said audio sensing, and whereby a continued user presence in said user interaction area or in a further user interaction area within said supervised environment is monitored with precedence given to said thermal imaging.

2. The environment control network of claim 1, wherein said microcontroller is configured to issue an executable instruction to said at least one smart device upon said at least one smart device reporting a predetermined status to said microcontroller via said device communication channel.

3. The environment control network of claim 2, wherein said at least one smart device is selected from the group consisting of audio equipment, video equipment, smart phone, computer, temperature sensor, fan, heater, door entry unit, smart TV, HVAC system, smart appliance, lighting, smart furniture, smart window curtains, pool heater, irrigation unit, smart garden device, smart gate entry, home security surveillance device, smart power switch.

4. The environment control network of claim 2, wherein at least one of said at least one smart device and said environment control device further comprises an indicator unit for indicating said predetermined status.

5. The environment control network of claim 4, wherein said indicator unit comprises at least one device selected from the group consisting of a light emitting diode and an audio unit.

6. The environment control network of claim 1, wherein said microcontroller is configured to issue an executable instruction to said at least one smart device upon detection of a predetermined status in said supervised environment from any combination of said thermal imaging, said optical imaging, said proximity sensing and said audio sensing.

7. The environment control network of claim 1, wherein said supervised environment is selected from the group consisting of home environment, office environment, industrial environment, outdoor environment and indoor environment.

8. The environment control network of claim 1, wherein said device communication channel is selected from the group consisting of WiFi, Bluetooth, Bluetooth 5.

9. The environment control network of claim 1, further comprising a machine learning module connected to said environment control device.

10. An environment control network for controlling a supervised environment, said environment control network comprising:
a) an environment control device having:
1) at least one thermal viewer having a thermal field of view for performing thermal imaging of a user interaction area within said supervised environment;
2) at least one optical viewer having a visual field of view for performing optical imaging of said user interaction area;
3) at least one proximity sensor for proximity sensing within said user interaction area;
4) at least one audio sensor for audio sensing within said user interaction area;
5) a microcontroller connected to said at least one thermal viewer for obtaining a thermal image, and connected to said at least one optical viewer for obtaining an optical image, and connected to said at least one proximity sensor for obtaining a proximity read, and connected to said at least one audio sensor for obtaining an audio signal;
b) at least one smart device in communication with said environment control device via a device communication channel;
c) a memory in communication with said microcontroller, said memory containing an authorized user credentials and an authorized user profile; wherein
said microcontroller is configured to trigger at least one personalized function involving said smart device upon establishing an authorized user presence in said user interaction area based on verification of said authorized user credentials and upon further user detection from said thermal imaging and at least one of said optical imaging, said proximity sensing and said audio sensing, and whereby a continued user presence in said user interaction area or in a further user interaction area within said supervised environment is monitored with precedence given to said thermal imaging.

11. The environment control network of claim 10, wherein said microcontroller is configured to issue an executable instruction to said at least one smart device upon said at least one smart device reporting a predetermined status to said microcontroller via said device communication channel.

12. The environment control network of claim 11, wherein said at least one smart device is selected from the group consisting of audio equipment, video equipment, smart phone, computer, temperature sensor, fan, heater, door entry unit, smart TV, HVAC system, smart appliance, lighting, smart furniture, smart window curtains, pool heater, irrigation unit, smart garden device, smart gate entry, home security surveillance device, smart power switch.

13. The environment control network of claim 11, wherein at least one of said at least one smart device and said environment control device further comprises an indicator unit for indicating said predetermined status.

14. The environment control network of claim 13, wherein said indicator unit comprises at least one device selected from the group consisting of a light emitting diode and an audio unit.

15. The environment control network of claim 10, wherein said microcontroller is configured to issue an executable instruction to said at least one smart device upon detection of a predetermined status in said supervised environment from any combination of said thermal imaging, said optical imaging, said proximity sensing and said audio sensing.

16. The environment control network of claim 10, wherein said supervised environment is selected from the group consisting of home environment, office environment, industrial environment, outdoor environment and indoor environment.

17. The environment control network of claim 10, wherein said device communication channel is selected from the group consisting of WiFi, Bluetooth, Bluetooth 5.

18. The environment control network of claim 10, further comprising a machine learning module connected to said environment control device.
